(19) United States
(12) Patent Application Publication
(10) Pub. No.: US 2026/0208753 A1
(43) Pub. Date: Jul. 23, 2026

(54) METHOD FOR CONTROLLING A MOTOR VEHICLE IN THE EVENT OF A FAULT IN THE FRONT AXLE STEERING, AND EMERGENCY STEERING SYSTEM

(71) Applicants: thyssenkrupp Presta AG, Eschen (LI); thyssenkrupp AG, Essen (DE)

(72) Inventors: Dominik LANG, Goetzis (AT); Leonard LAPIS, Sennwald (CH); Kristof POLMANS, Tarrenz (AT); Alexander SCHEIDT, Au (CH); Imre SZEPESSY, Mauren (LI); Akos DOBCSANYI, Mauren (LI)

(73) Assignees: thyssenkrupp Presta AG, Eschen (LI); thyssenkrupp AG, Essen (DE)

(21) Appl. No.: 19/140,920

(22) PCT Filed: Dec. 18, 2023
(86) PCT No.: PCT/EP2023/086471

§ 371 Date: Jun. 18, 2025

(30) Foreign Application Priority Data
Dec. 20, 2022 (BE) BE 2022/6038
Dec. 20, 2022 (BE) BE 2022/6039
Dec. 20, 2022 (BE) BE 2022/6040

(51) Int. Cl. B60W 50/029; B60W 10/184; B60W 10/20; B60W 40/10; B62D 7/14; B62D 9/00

(52) U.S. Cl. CPC B60W 50/029; B60W 10/184; B60W 10/20; B60W 40/10; B62D 7/148; B62D 9/005; B60W 2050/0292; B60W 2510/182; B60W 2510/20; B60W 2520/10; B60W 2520/14; B60W 2520/30; B60W 2710/18; B60W 2710/20

(57) ABSTRACT

A method for controlling a motor vehicle having a steer-by-wire steering system with front-axle steering unit and rear-axle steering unit in the event of a fault being detected in the front-axle steering unit, comprises vehicle signals relating to a steering input, a position of a steering rack of the front-axle steering unit and a yaw rate of the motor vehicle being detected, the detected vehicle signals being made available to a control unit, the control unit, in order to implement the steering input, generating a first control signal for controlling a steering adjuster of the rear-axle steering unit, wherein the first control signal is generated taking into consideration the steering input, the position of the steering rack of the front-axle steering unit and the yaw rate, and controlling the steering adjuster of the rear-axle steering unit by the generated first control signal.

The invention relates to a method for controlling a motor vehicle having a steer-by-wire steering system having a front axle steering system and a rear axle steering system in the event of an identified fault of the front axle steering system, wherein vehicle signals relating to a steering specification, a position of a toothed rack of the front axle steering system and a yaw rate of the motor vehicle are detected, the detected vehicle signals are provided to a control unit and the control unit generates a control signal. The invention further relates to an emergency steering system for providing a steering capacity of a motor vehicle having a steer-by-wire steering system having a front axle steering system and a rear axle steering system in the event of failure of the front axle steering system.

Steer-by-wire steering systems are described many times in the prior art. For example, DE 10 2018 114 988 A1 discloses a steer-by-wire steering system having a steering handle, a feedback actuator and a steering actuator, wherein a steering instruction can be predetermined via the steering handle and can be converted by the steering actuator into a steering movement of steerable wheels of a motor vehicle. A challenge with steer-by-wire steering systems involves keeping a motor vehicle controllable even in the event of an occurrence of faults in the steer-by-wire steering system. In this regard, DE 10 2020 100 719 A1 proposes switching off the defective steering system in a motor vehicle with a front axle and rear axle steering system in the event of a fault of the front axle or rear axle steering system and allowing a steering movement by means of an autonomous driving mode or a derived intended movement. DE 10 2019 217 588 A1 further discloses that after a vehicle collision, as a result of which one or more wheels of a vehicle axle can no longer be completely steered or cannot even be steered any more, steering is carried out by means of the functional steering axle and a brake signal is transmitted to one of the vehicle wheels connected to this steering axle.

DE 10 2018 107 612 A1 further discloses a motor vehicle having a front axle and rear axle steering system and torque vectoring on the rear axle, wherein there is provision for an actual motor vehicle state to be compared with a desired motor vehicle behavior of a motor vehicle. Using the rear axle steering system and a rear wheel drive to control the rear wheels, the actual motor vehicle state is approximated to the desired motor vehicle behavior in this case. It is further disclosed that, in the event of a failure of the front axle steering system and the front axle drive, the rear axle steering system and the rear axle drive can take over the control of the motor vehicle.

WO 2017/001045 A1 also describes a motor vehicle having a front axle steering system and a rear axle steering system. In this case, an automatically controlling front axle steering system is provided for autonomous driving. A failure identification device can identify a failure of the front axle steering system in this case, wherein the steering of the vehicle is then carried out by the rear axle steering system. Furthermore, in the event of a failure of the front axle steering system the front wheels are braked so that a central centering of the front axle steering system is carried out.

EP 2 072 374 A2 further discloses an apparatus for damping a rear axle steering system, wherein an electric motor which drives a steering actuator which acts on the rear axle is operated to damp the rear axle steering system during generator operation.

On this basis, there is a further need to keep a motor vehicle with a steer-by-wire steering system controllable in the event of the occurrence of faults in or on the steering system and thus to further reduce the risk of personal injury.

Against this background, an object of the present invention is to improve a motor vehicle having a steer-by-wire steering system comprising a front axle steering system and a rear axle steering system, and particularly to keep the motor vehicle in a steerable state in an improved manner in the event of a fault of the front axle steering system.

In order to achieve this object, there are proposed a method for controlling a motor vehicle having a steer-by-wire steering system having a front axle steering system and a rear axle steering system and an emergency steering system according to the independent claims. Additional advantageous configurations of the invention are described in the dependent claims and the description and illustrated in the Figures.

The proposed solution makes provision for a method for controlling a motor vehicle which has a steer-by-wire steering system having a front axle steering system and a rear axle steering system in the event of an identified fault of the front axle steering system, wherein vehicle signals relating to a steering specification, a position of a toothed rack of the front axle steering system and a yaw rate of the motor vehicle are detected, the detected vehicle signals are provided to a control unit and the control unit in order to convert the steering specification generates a first control signal for controlling a steering actuator of the rear axle steering system. The first control signal is generated according to the invention taking into consideration the steering specification, the position of the toothed rack of the front axle steering system and the yaw rate, and the steering actuator of the rear axle steering system is controlled with the generated first control signal. Advantageously, by taking into consideration the steering specification and the position of the toothed rack and additionally taking into consideration the yaw rate of the motor vehicle, an improved capacity for steering the motor vehicle is achieved in the event of an occurrence of a fault relating to the front axle steering system. In particular, a failure of the capacity for control of the front axle steering system is identified as a fault of the front axle steering system, wherein a toothed rack of the front axle steering system can particularly be freely movable. In particular, however, a blocked or damped steering action is also identified as a fault of the front axle steering system. In particular, a fault of the front axle steering system is identified when a predetermined steering instruction can no longer be converted by means of the front axle steering system. The fault of the front axle steering system may in this case be attributed in particular to an accident of the vehicle. In this instance, a vehicle advantageously remains steerable by means of the method until the vehicle is safely stopped. In particular, possible obstacles can still be driven round until the vehicle is safely stopped. The motor vehicle is particularly a two-track motor vehicle, in particular a two-track passenger vehicle which has two front wheel and two rear wheels.

According to an advantageous embodiment of the method, the control unit generates, for converting the steering specification, a second control signal for controlling a front brake of the motor vehicle, at least one front wheel brake of the motor vehicle and/or a rear brake of the motor vehicle, at least one rear wheel brake of the motor vehicle, wherein the front brake and/or the rear brake are advantageously controlled with a generated second control signal. In particular, there is provision in this case for, as a result of the control of the front brake and the rear brake, a travel direction of the motor vehicle to be intended to be influenced in the context of a detected steering specification. Advantageously, the front brake and the rear brake are used in a directionally dependent manner by means of the second control signal, in particular in accordance with a steering specification by a driver or an autonomous motor vehicle control unit. In a further advantageous manner, during the generation and use of the second control signal it is taken into consideration whether the vehicle should be braked or not. If, by means of the second control signal, the front brake and/or the rear brake are used to generate a yaw moment acting on the vehicle, a compensation torque which advantageously maintains the speed of the vehicle is advantageously provided.

An advantageous further development of the method makes provision for a vehicle signal relating to an acceleration specification, in particular actuation of a brake pedal and/or actuation of an accelerator pedal, to be additionally detected, wherein taking into consideration the acceleration specification a brake pressure for the front brake and/or the rear brake is calculated as the second control signal. In particular, there is provision for a brake pressure to be predetermined for each wheel of the vehicle with the second control signal. In particular, it is further advantageously taken into consideration whether a driver wishes to brake the vehicle or not. In particular, there is further provision, at times when no braking is detected as an acceleration specification, for a compensation torque which maintains the vehicle speed to be provided for a yaw moment which is produced by controlling the front brake and/or the rear brake. This provision of a compensation torque is advantageously dispensed with when braking is detected as the acceleration specification.

According to another advantageous embodiment of the method, a vehicle signal relating to a vehicle speed is additionally detected, wherein a reference value for a yaw rate of the motor vehicle is established taking into consideration the vehicle speed and the calculated brake pressure. Advantageously, the reference value is used for a yaw rate of the motor vehicle by a yaw regulator of the motor vehicle, in particular by an active yaw regulation system which is advantageously used in a supporting manner in order to convert a steering specification in the event of a failed front axle steering system. Advantageously, a further improved steering capacity can thereby be achieved.

Another advantageous embodiment makes provision for, taking into consideration the steering specification and the position of the toothed rack of the front axle steering system, a steering actuator signal for the steering actuator of the rear axle steering system to be generated, for a yaw regulator to generate a control signal for determining a torque distribution at wheels of the motor vehicle taking into consideration the yaw rate of the motor vehicle and for the first control signal to be generated from a superimposition of the steering actuator signal and the control signal. Advantageously, a steering capacity of the motor vehicle when the front axle steering system has failed is thereby further improved. In particular, in this case the rear wheel steering system becomes the main actuator for the steering in the case of a defective front axle steering system, in particular in the case of a defective front wheel toothed rack, wherein advantageously the rear wheel steering system is controlled with a forward steering component, in particular the steering specification and the position of the toothed rack of the front wheel steering system, and a superimposed yaw regulator. The superimposed yaw regulator, in particular the control signal which is generated by the yaw regulator, advantageously reduces disruptive influences, such as in particular a u-split braking. There is further advantageously provision for a difference involving the detected vehicle signal relating to the yaw rate of the motor vehicle and the established reference value for the yaw rate to be provided to the yaw regulator as an input variable.

In a further advantageous manner, a specification with respect to a desired yaw rate to be achieved of the motor vehicle is provided and may particularly correspond to the established reference value for the yaw rate of the motor vehicle, and taking into consideration a current actual yaw rate of the motor vehicle determines a brake specification for at least one of the wheels of the motor vehicle in order to bring the actual yaw rate closer to the desired yaw rate. Preferably, a brake application is carried out in accordance with the determined brake specification. In particular, a method is proposed for steering in a supporting manner a two-track motor vehicle which has two front wheels and two rear wheels, wherein a specification with respect to a desired yaw rate to be achieved of the motor vehicle is provided, taking into consideration a current yaw rate of the motor vehicle a brake specification for at least one of the wheels of the motor vehicle is determined in order to approximate the actual yaw rate to the desired yaw rate and a brake application is carried out in accordance with the determined brake specification.

The provision of a specification with respect to a desired yaw rate to be achieved of the motor vehicle, the determination of a brake specification for at least one of the wheels of the motor vehicle taking into consideration a current actual yaw rate of the motor vehicle in order to approximate the actual yaw rate to the desired yaw rate and the provision of a brake application in accordance with the determined brake specification are based on the notion of generating a moment about the vertical axis by unilaterally introducing a brake torque into a two-track motor vehicle with two front and two rear wheels, which moment is advantageously used in order to support the functionally impaired steer-by-wire steering system of the motor vehicle when carrying out a change in travel direction and/or in order to control the motor vehicle alone therewith, particularly when a steering capacity is not otherwise provided. If a brake torque acts mainly on the front axle of a two-track motor vehicle, then it acts on the motor vehicle in a rather under-steering manner while a more powerful brake torque acts on the rear axle of the motor vehicle in a rather over-steering manner. This property is advantageously used in order to optimize the steering behavior of the vehicle, in particular in the event of an at least partial failure of a steer-by-wire steering system of a motor vehicle, in particular in the event of a functional impairment of the front axle steering system. The actual yaw rate is advantageously measured. This can particularly be carried out by a measuring apparatus of a present ESP (electronic stability program) or by an additional sensor unit. This rate is advantageously used with other values, in particular the steering angles, transverse accelerations and/or wheel speeds, in order to achieve a more precise determination of the real actual yaw rate.

According to an advantageous embodiment of the method, the specification with respect to the desired yaw rate is provided taking into consideration a steering specification. The steering specification can in this case be predetermined in particular by a driver via a steering handle or during at least partially autonomous driving operation of the motor vehicle by a driver assistance system. Advantageously in this case, a brake torque is introduced in such a manner that the motor vehicle better follows the steering specification.

In particular, there is provision for the desired yaw rate to correspond to the established reference value for the yaw rate of the motor vehicle. According to one variant, the desired yaw rate is determined on the basis of the desired steering angles of the front and rear wheels. The desired steering angles are in this case determined in particular on the basis of a detected steering specification, wherein, in the case of a steering specification by means of a steering wheel, the desired steering angles are calculated in particular from the steering wheel angle and steering wheel rotational speed, in particular with further consideration of the vehicle speed, the fixed variables with respect to the wheel base and/or the inherent steering gradient.

In particular, the desired yaw rate can be determined according to the functional relationship set out below:

$${ψ}_{d} = \frac{{δ}_{t} * v}{l + {v}^{2} * EG} ,$$

$$where :$$

$${ψ}_{d} = desired yaw rate ;$$

$$v = vehicle speed ;$$

$$l = wheel base ;$$

$$EG = inherent steering gradient ; and$$

$${δ}_{t} = a tan ( tan ( {δ}_{f} ) - tan ( {δ}_{r} ) ) , with$$

$${δ}_{f} = desired steering angle of front wheels ; and$$

$${δ}_{r} = desired steering angle of rear wheels .$$

An advantageous further development makes provision for the above-described brake specification to be determined based on a two-track model, wherein the two-track model particularly describes the stationary and non-stationary transverse dynamics of the motor vehicle. The two-track model is advantageously solved for its stationary states so that a desired yaw rate as the input of the two-track model advantageously produces a brake torque difference necessary for achieving the desired yaw rate as the output. In particular, there is provision for the specification with respect to the desired yaw rate to be supplied as the input variable to the two-track model and using the two-track model for a presumed stationary state of the motor vehicle as the output variable a brake torque difference resulting therefrom between the wheels to be established, wherein the brake specification is advantageously determined from the brake torque difference. In this case, in particular the brake torque difference between the left and right wheels is formed.

According to another advantageous further development, a scaling factor is applied to the established brake torque difference, wherein the scaling factor is less than 1. This embodiment is provided in particular for supporting the steering, that is to say particularly when the steering of the motor vehicle is at least still partially functional, that is to say in particular the rear axle steering system or the rear axle steering system and at least to a specific extent the front axle steering system is still functional.

It has been established in tests that this scaling factor depending on the maneuver is preferably in a range between 0.05 and 0.2, more preferably in a range between 0.05 and 0.1. Another advantageous embodiment therefore makes provision for a current driving maneuver to be evaluated from driving state information items, that is to say in particular information items which relate to the current driving state of the motor vehicle, in particular a vehicle speed. Depending on the evaluation of the driving maneuver, the scaling factor is advantageously determined in this case with a value in a range from 0.05 to 0.2, in particular in a range from 0.05 to 0.1. In this case, driving maneuvers in the fringe range advantageously lead to a smaller value for the scaling factor, whereas a so-called “limp aside” driving maneuver advantageously leads to a greater value for the scaling factor. In a further advantageous manner, the scaling factor is in particular speed-dependent, wherein a high travel speed advantageously leads to a high scaling factor within the determined range and a low travel speed advantageously leads to a low scaling factor within the determined range.

In a further advantageous manner, the embodiment of the method with the brake application is applied in accordance with the determined brake specification in the event of an identified, at least partial failure of the steer-by-wire steering system of the motor vehicle, wherein the scaling factor is advantageously determined with a higher value, the lower is the steering action which can still be provided by the steering system. In this case, it is advantageously possible to achieve as a result of the selective brake application the state that the motor vehicle better follows a steering specification than would be the case only with the steering action which can still be provided by the steering system. In this regard, there is proposed in particular a method for steering in a supporting manner a two-track motor vehicle which has two front wheels and two rear wheels, wherein an at least partial failure of a steer-by-wire steering system is identified, taking into consideration a detected steering specification a specification with respect to a desired yaw rate to be achieved of the motor vehicle is provided, with further consideration of a current actual yaw rate of the motor vehicle a brake specification for at least one of the wheels of the motor vehicle is determined in order to approximate the actual yaw rate to the desired yaw rate, and a brake application is carried out in accordance with the determined brake specification, wherein the determination of the brake specification is carried out in particular on the basis of a two-track model, in particular as described above.

In particular, there is provision for a force difference ΔFₓ between the front axle and rear axle of the motor vehicle to be determined in order to determine the brake specification on the basis of the two-track model, wherein on the basis of the determined force difference in particular a brake pressure with which the motor vehicle is selectively braked is determined. The determination of the brake pressure is advantageously carried out in this case on the basis of the established force difference taking into consideration the wheel diameter of the wheels of the motor vehicle and the so-called cₚ value which describes a relationship between the brake pressure and the torque. The cₚ value is in this instance experimentally established in particular for a respective vehicle model by the measured brake pressure and the occurring brake torque being compared.

According to an advantageous embodiment, the force difference ΔFₓ is determined as follows:

$$Δ {F}_{x} = \ddot{ψ} * \frac{2 {c}_{α} {l}_{f}^{2} + 4 {c}_{α} {l}_{f} {l}_{r} - m {l}_{f} {v}^{2} + 2 {c}_{α} {l}_{r}^{2} + m {l}_{r} {v}^{2}}{2 v} ,$$

where:
\ddot{ψ}: yaw acceleration,
c_{α}: lateral tire rigidity,
l_{f}: spacing of front axle of motor vehicle from center of mass of the motor vehicle,
lᵣ: spacing of rear axle of motor vehicle from center of mass of the motor vehicle,
m: vehicle mass, and
v: local speed (vehicle speed).

An advantageous variant makes provision for the brake specification to be calculated, wherein advantageously a desired yaw moment to be achieved is determined from the desired yaw rate and is proportional to the desired yaw rate, and wherein the desired yaw moment is advantageously multiplied by a value for a current travel speed of the motor vehicle. In particular, there is provision in this case for a brake pressure to be calculated by a desired yaw moment which is proportional to the desired yaw rate which is advantageously determined from a steering angle of a steering handle of the motor vehicle being multiplied by the vehicle speed. In particular, the determination of the brake pressure is based in this embodiment on the determination of the force difference ΔFₓ for

$$Δ {F}_{x} = \ddot{ψ} * v * C ,$$

where:
\ddot{ψ}: yaw acceleration,
v: local speed (vehicle speed), and
C: constant, in particular with C= [80 . . . 100], more particularly with C=95.

Therefore, there is provision as an advantageous embodiment for determining the brake specification for a brake pressure for at least one specific wheel of the wheels of the motor vehicle to be determined as the brake specification, in particular for the wheels of an axle of the motor vehicle. Advantageously, the brakes of the motor vehicle are actuated with the determined brake pressure. Advantageously, a higher brake pressure is determined, the higher is the travel speed of the motor vehicle.

In particular, there is provision for the method in which a brake specification is determined to be carried out in the event of an identified, at least partial failure of the steer-by-wire steering system of the motor vehicle, wherein such a partial failure of the steering system in particular in the case of an all-wheel steering system is a failure of the steering capacity of the front axle of the motor vehicle by means of the steering system by controlling the corresponding steering actuator. Advantageously, in such a partial failure of the steering system a supporting steering is carried out by the advantageously additionally provided brake application. According to another advantageous embodiment of the method which is proposed to achieve the object mentioned in the introduction, additionally a vehicle signal relating to the response of a front brake of the motor vehicle is detected and provided to the control unit, wherein the control unit generates a brake torque compensation as the third control signal taking into consideration the response of the front brake of the motor vehicle and a drive train of the motor vehicle is controlled with the third control signal. In particular, there is thereby further improved the fact that the motor vehicle follows a steering specification, in particular further taking into consideration an acceleration specification.

Another advantageous embodiment makes provision for a movement of the toothed rack of the front axle steering system to be damped, particularly when the toothed rack is freely movable. Advantageously, the steering influence by the defective front axle steering system is thereby reduced. In particular, there is provision for the control unit to generate a fourth control signal for controlling a short-circuiting circuit of an electric motor of a steering actuator of the front axle steering system, wherein phases of the electric motor are short-circuited by the control with the fourth control signal and consequently a movement of the toothed rack of the front axle steering system is damped.

According to another aspect, there is generally provision for a movement of a functionally impaired axle steering system to be damped, in particular in order to avoid an externally forced adjustment of undesired wheel steering angles of wheels of the functionally impaired axle steering system. Advantageously, in particular the movement of the functionally impaired axle steering system is damped when a wheel steering angle which is favorable for a steering specification is adjusted. In particular, in this case the functional axle steering system is used to convert the steering specification. Advantageously, the functional axle steering system can be supported here by selective brake applications, introduced drive torques and/or additional control interventions. In particular, there is provision for the damping for a substantial damping moment to be applied to an electric motor of a road wheel actuator of the steer-by-wire steering system, in particular to an electric motor of a steering actuator of the steer-by-wire steering system, preferably by the electric phases of the electric motor being short-circuited. The resultant damping force is advantageously used in order to keep the wheel steering angles of the functionally impaired axle steering system constant, in particular the wheel steering angles of the front road wheels, in particular so that the motor vehicle can be steered via the rear axle steering system.

Advantageously, in this variant the motor phase short-circuit is activated by the control unit, in particular by a driving state determination device, more particularly by a driving dynamics control unit which advantageously identifies the state of the motor vehicle and steers after the failure of the axle affected by a functional disruption. If an additional damping is used, in particular by a motor phase short-circuit, unintended steering movements, which are caused by dynamic lateral forces, of the wheels which are no longer selectively steerable are advantageously braked, in particular by the friction and the generated damping.

Advantageously, this effect can limit disruptive reactions of the still functional axle steering system, in particular the functional rear wheel steering system, wherein advantageously a slow steering via an alternative steering system by braking or driving continues to be possible and can advantageously be selectively used. It is thereby advantageously possible to further improve the capacity to control the motor vehicle in the event of a defect of the steering system. This proposed embodiment can particularly be very useful in the event of emergency braking, during which despite the defective steering system the lane is intended to be maintained or in the case of a slow avoiding movement. Advantageously, the control unit identifies a failure of an electric steering actuator of the front axle steering system and activates the phase short-circuit at the electric servo motor thereof so that advantageously the wheel steering angle of the front wheels is fixed. The control unit then advantageously transmits reference position information items to the rear axle steering system on the basis of a measured steering wheel position.

In particular, there is also provision for a damping of the defective axle steering system and an alternative steering function, in particular by selectively braking wheels of the motor vehicle and/or by steering the still-steerable wheels of the functional axle steering system, to work in a parallel manner. In this case, advantageously the damping function is selectively switched on and off in order thus to be able to adjust desired wheel steering angles indirectly and thus to further improve the steering control.

According to another advantageous further development of the method, a driving state determination device determines a driving state of the motor vehicle taking into consideration available vehicle signals, in particular taking into consideration all the available driving signals. The determination of the driving state advantageously comprises in this instance an evaluation as to whether the motor vehicle is travelling in urban traffic, across country or on a motorway. The driving state determined by the driving state determination device is advantageously provided to the control unit. Advantageously, the additional control signals are adapted in accordance with the determined driving state. The control unit considers particularly the driving state for generating at least one of the control signals, in particular for generating the first control signal, the second control signal, the third control signal and/or the fourth control signal. Advantageously, the steering capacity is thus adapted to a current driving state in an improved manner depending on the situation. In particular, it is thus possible to obtain further improved results with respect to the yaw regulation and in particular to predetermine a suitable brake pressure for the front brake and/or the rear brake in a manner adapted even better.

Another advantageous embodiment makes provision for a first wheel steering angle of the front wheels to be additionally detected and using the rear axle steering system in order to convert the steering specification a second wheel steering angle of the rear wheels to be adjusted, a first desired steering angle for the front wheels to be determined from the detected steering specification and a second desired steering angle for the rear wheels to be determined, and for the second wheel steering angle to be determined taking into consideration the determined first desired steering angle, the determined second desired steering angle and the detected first wheel steering angle. In particular, there is provided a method for operating a steer-by-wire steering system in a motor vehicle having a first steering system for steering first wheels on a first axle of the motor vehicle, in particular having a front axle steering system, and a second steering system for steering second wheels on a second axle of the motor vehicle, in particular a rear axle steering system, wherein a steering specification for the motor vehicle is detected, a first wheel steering angle of the first wheels, in particular the front wheels, is detected and using the second steering system for converting the steering specification a second wheel steering angle of the second wheels, in particular the rear wheels, is adjusted, wherein a first desired steering angle for the first wheels of the motor vehicle, in particular the front wheels of the motor vehicle, and a second desired steering angle for the second wheels, in particular the rear wheels, for the motor vehicle is determined from the detected steering specification, and the second wheel steering angle is determined taking into consideration the determined first desired steering angle, the determined second desired steering angle and the detected first wheel steering angle is determined. Since in many steering maneuvers, both steering systems are not used, but instead only the first steering system, in particular the front axle steering system, is used to convert a steering specification, the second desired steering angle can be determined for these steering maneuvers in particular at 0°, a direct use of the second steering system, in particular the rear axle steering system, for these steering maneuvers may therefore not be provided. By considering the first desired steering angle, the second desired steering angle and the detected first wheel steering angle, it is advantageously possible to determine the second wheel steering angle of the wheels of the second steering system, in particular the rear axle steering system, advantageously so that the motor vehicle follows a steering specification as precisely as possible, particularly when the first steering system which preferably corresponds to the front axle steering system is no longer suitable as a result of a functional failure or at least suitable only in a limited manner for converting a steering specification. Thus, an application of the method is provided particularly when the first steering system, in particular the front wheel steering system, of a passenger vehicle is no longer fully functional after a collision or by another cause and the front wheels, in particular the front wheels, can still be steered only in a limited manner, therefore in particular only a smaller steering angle than predetermined can be adjusted.

In order to detect the first wheel steering angle, there is in particular provision for it to be measured, in particular by means of a correspondingly configured sensor unit. Alternatively or additionally, in order to detect the first wheel steering angle there is provision for it to be estimated, in particular by means of a state estimator. The estimation is preferably carried out in this case so that a rear axle position is determined from a measured position at the second steering system. By means of the measured rear axle position, an introduced yaw rate and by means of measured wheel speeds, the first steering angle position is advantageously estimated.

According to a particularly advantageous embodiment, there is provision for the second wheel steering angle to be determined, with

$${β}_{adapt} = a tan ( tan ( {α}_{Soll} ) + tan ( {β}_{Soll} ) - tan ( {α}_{Ist} ) ) , where$$

$${β}_{adapt} = second wheel steering angle ( to be adjusted ) ,$$

$${α}_{Soll} = first desired steering angle for the first wheels ( front wheels ) ;$$

$${β}_{Soll} = second desired steering angle for the second wheels ( rear wheels ) ;$$

$$and$$

$${α}_{Ist} = ( detected ) first wheel steering angle .$$

Advantageously, the problem of determining the second wheel steering angle is solved by a corresponding kinematic radius being calculated from the steering specification and a first and second desired steering angle being determined and subsequently advantageously the second wheel steering angle, which is necessary for converting the steering specification, being calculated with additional consideration of the measured actual first wheel steering angle, advantageously according to the above equation.

In particular, there may be provision for the first steering system, in particular the front axle steering system, to be a main steering system of the motor vehicle, with which during normal operation of the motor vehicle, in particular in the collision-free state, a steering specification is converted, in particular with which in a normal operating mode a steering specification alone, that is to say without using the second steering system, in particular the rear axle steering system, is converted. The second steering system, that is to say in particular the rear axle steering system, is in this case advantageously a supporting steering system, with which during normal operation, in particular in the collision-free state, in predetermined driving situations the main steering system can be supported in order to support the steering specification, in particular in order to improve the driving behavior of the motor vehicle in comparison with a motor vehicle which comprises only the main steering system, in particular in order to reduce a turning circle of the motor vehicle during parking operations, an increase of the dynamics of the driving behavior in sports mode of the motor vehicle and/or a stabilization of the motor vehicle in a manner dependent on the driving situation. The main steering system is in this case in particular the front axle steering system of the motor vehicle and the supporting steering system is in particular the rear axle steering system of the motor vehicle which advantageously form a so-called all-wheel steering system together during normal operation. In the event of a functional impairment of the front axle steering system, in particular in the case of a collision-related failure of the front axle steering system, in which a specific first desired steering angle in particular no longer or no longer completely can be adjusted by the front axle steering system, the supporting steering system, that is to say the rear axle steering system, the steering system with which the motor vehicle is advantageously further kept in a state able to be maneuvered, and in particular a steering specification will then advantageously be able to be carried out. In particular, there is provision for, in the event of failure of the front axle steering system, the still functional rear axle steering system to be able to additionally be supported during the conversion of steering specifications by selectively controlling actuators which act on the wheels of the vehicle, such as brakes and/or drive units.

Advantageously, during operation of the steer-by-wire steering system in a motor vehicle the functionality of at least the first steering system, in particular the functionality of the first steering system and the functionality of the second steering system, is monitored and a failure of the first steering system is identified and the steering system in the motor vehicle is operated following the identification of the failure of the first steering system so that a steering specification for the motor vehicle is detected, a first wheel steering angle of the first wheels is detected, from the detected steering specification a first desired steering angle of the first wheels of the motor vehicle and a second desired steering angle of the second wheels of the motor vehicle is determined, the second wheel steering angle is determined taking into consideration the determined first and second desired steering angle and the detected first wheel steering angle and using the second steering system the determined second wheel steering angle of the second wheels is adjusted in order to convert the steering specification.

In particular, there is provision for the steering specification to be predetermined by a driver in order to steer the motor vehicle in the method via a steering handle, in particular via a steering wheel. However, there is provision as an advantageous variant for the steering specification to be predetermined by a driver assistance system in order to steer the motor vehicle, in particular by a driver assistance system which is configured to bring the motor vehicle safely to a stop after the occurrence of a collision of the motor vehicle, in particular avoiding further collisions. It is advantageously possible to prevent such further collisions by means of the method proposed according to the invention, particularly because the motor vehicle remains capable of being maneuvered and it is further advantageously possible for a steering movement to be converted therefor of the steered wheels of the second axle to be determined in a comparatively precise manner.

A further development of the above-described embodiments of the method makes provision for, in a normal operating mode of the steer-by-wire steering system, in particular in a normal operating mode comprising a plurality of normal operating modes of the steer-by-wire steering system, only the front axle steering system to be used to convert the detected steering specification and the second desired steering angle for the rear wheels in this normal operating mode is consequently determined or fixed at 0°. The second desired steering angle therefore remains unconsidered in this normal operating mode which advantageously covers many kilometers of travel of a motor vehicle. In this special normal operating mode, the second wheel steering angle is therefore advantageously determined in a simplified manner, when a functional impairment of the front axle steering system is identified, with

$${β}_{adapt} = a tan ( tan ( {α}_{S o l l} ) - tan ( {α}_{Ist} ) ) .$$

The further proposed solution of the problem mentioned in the introduction makes provision for an emergency steering system for providing a capacity for steering a motor vehicle having a steer-by-wire steering system having a front axle steering system and a rear axle steering system, in the event of failure of the front axle steering system, comprising a control unit, wherein a steering actuator of the rear axle steering system and actuators of the motor vehicle outside the steer-by-wire steering system are associated with the control unit, and wherein a sensor unit for detecting a vehicle signal which relates to a steering specification and additional sensor units for detecting additional vehicle signals are associated with the control unit. In this case, the control unit of the emergency steering system is configured to receive vehicle signals from the associated sensor units and to generate, from the received vehicle signals for converting the received steering specification, control signals for the steering actuator, which is associated with the control unit, of the rear axle steering system and the actuators of the motor vehicle outside the steer-by-wire steering system. Advantageously, with the emergency steering system the capacity for steering the motor vehicle is improved in that not only the still functional rear axle steering system is used to convert a steering specification, which in many situations may be inadequate, but furthermore at least one additional actuator of the motor vehicle which is not originally associated with a steering system is controlled, such as in particular a front brake of the motor vehicle, in particular a brake unit which is associated with a respective front wheel, and/or a rear brake of the motor vehicle, in particular a brake unit which is associated with a respective rear wheel, and/or at least one drive unit of the motor vehicle. The emergency steering system 1 advantageously comprises in this regard at least one actuator of the steer-by-wire steering system and at least one additional actuator of the motor vehicle which originally is not included in the steer-by-wire steering system. Advantageously, vehicle assistance systems connected to this actuator are used for controlling the at least one additional actuator of the motor vehicle and are advantageously controlled by the control unit of the emergency steering system.

The additional sensor units which are associated with the control unit of the emergency steering system comprise in particular at least one of the following sensor units: sensor unit for detecting the actuation of a brake operating element, in particular a brake pedal; sensor unit for detecting the actuation of an acceleration operating element, in particular an accelerator pedal; sensor unit for detecting the position of a toothed rack of the front axle steering system; sensor unit for detecting the vehicle speed; sensor unit for detecting the yaw rate of the motor vehicle. According to an advantageous embodiment, all of the above-mentioned sensor units are associated with the control unit of the emergency steering system. In place of the sensor unit for detecting the position of a toothed rack of the front axle steering system, it is also in particular possible to provide an estimation unit, with which one position of a toothed rack of the front axle steering system can advantageously be established by estimation. Advantageously, the control unit is configured to establish a driving state precisely by means of the vehicle signals which are detected by the sensor units and to control the steering actuator of the rear axle steering system and the additional actuators of the motor vehicle so that the vehicle follows a steering specification in the event of a failure of the front axle steering system in a further improved manner.

The additional actuators of the motor vehicle which are associated in particular with the motor vehicle outside the steer-by-wire steering system comprise in particular at least one of the following actuators: front brake of the motor vehicle, in particular at least one front wheel brake of the motor vehicle; rear brake of the motor vehicle, in particular at least one rear wheel brake of the motor vehicle; drive train of the motor vehicle, in particular at least one motor provided for driving the motor vehicle, more particularly wheel hub motors which are associated with wheels of the motor vehicle. According to an advantageous embodiment, all the above-mentioned actuator units are associated with the control unit of the emergency steering system so that advantageously, in the event of identification of a fault of the front axle steering system, all the actuator units can be controlled by the control unit of the emergency steering system to convert a steering specification.

Another advantageous embodiment makes provision for a short-circuiting circuit of an electric motor of a steering actuator of the front axle steering system to be further associated with the control unit of the emergency steering system in addition, wherein the short-circuiting circuit is configured in the event of actuation to short-circuit phases of the electric motor and consequently to damp a movement of the toothed rack of the front axle steering system. If, in the event of a fault of the front axle steering system, the toothed rack of the front axle steering system is freely movable, advantageously the steering influence by the front axle can thereby be reduced and a steering movement of the motor vehicle can thus thereby be controlled in a further improved manner.

In a further advantageous manner, a driving state determination device is further associated with the control unit of the emergency steering system, wherein the driving state determination device is advantageously configured to determine a driving state of the motor vehicle taking into consideration detected vehicle signals and to provide it as an additional input signal for the control unit, wherein the control unit is further advantageously configured to consider the provided driving state for generating at least one of the control signals. In this case, the driving state of the motor vehicle relates in particular to an association as to whether the motor vehicle is travelling in urban traffic, across country or on a motorway. Carrying out steering maneuvers is thus advantageously able to be adapted to the situation in an improved manner.

Advantageously, the control unit is further configured to control a brake which is associated with a respective wheel, wherein the control unit or a processing unit associated with the control unit is advantageously configured to determine a brake specification, in particular a brake pressure as the brake specification, wherein the fixed values necessary for this, in particular a spacing of the front axle and the rear axle from the center of gravity, are preferably stored in the control unit or in the processing unit and the variable values, in particular the vehicle speed, are provided by sensors of the motor vehicle for the control unit or the processing unit. In particular, one configuration makes provision for the control unit to be configured to provide a specification with respect to a desired yaw rate to be achieved of the motor vehicle taking into consideration a detection steering specification and taking into consideration the state of the steering system, to determine a brake specification for at least one of the wheels of the motor vehicle in order to approximate the actual yaw rate to the desired yaw rate taking into consideration a current yaw rate of the motor vehicle and to carry out a brake application according to the determined brake specification. Advantageously, the emergency steering system is thereby supported by the control unit in order to convert the steering specification.

In a further advantageous manner, the control unit is configured to determine from the steering specification a first desired steering angle for the front wheels and a second desired steering angle for the rear wheels. Furthermore, there is advantageously provision for the emergency steering system to comprise a sensor unit for detecting a current first actual wheel steering angle of the front wheels. The control unit is advantageously further configured in this instance to control the steering actuator of the rear axle steering system, in the event of an at least partial failure of the front axle steering system taking into consideration the first desired steering angle for the front wheels and/or taking into consideration the second desired steering angle for the rear wheels and taking into consideration the first actual wheel steering angle, in such a manner that the steering actuator of the rear axle steering system adjusts a second wheel steering angle for the rear wheels in order to convert the steering specification. Advantageously, the emergency steering system configured in this manner thus enables in a further improved manner a motor vehicle, in which the front axle steering system has failed, in particular so that a steering specification can no longer be converted alone with the front axle steering system, to continue to be kept capable of maneuvering. The operational reliability of motor vehicles with such an emergency steering system is thus advantageously increased and users of such motor vehicles are thus better protected from injury.

According to an advantageous embodiment of the steering system, the front axle steering system is a main steering system for the motor vehicle which is particularly configured to convert a steering specification during normal operation, in particular in a normal operating mode from a plurality of normal operating modes, in particular without additionally using the rear axle steering system of the steering system. The rear axle steering system is advantageously a supporting steering system for the motor vehicle which is in particular configured to support the main steering system in order to convert the steering specification during normal operation in predetermined driving situations. In this configuration, in this regard only a first desired steering angle for the front wheels is regularly established from a steering specification and the second desired steering angle for the rear wheels is fixed at 0° so that in this regard during normal operation a steering specification is often converted only by the front axle steering system. The rear axle steering system is advantageously used during normal operation only in specific driving situations in a supporting manner with respect to the front axle steering system, in particular in order to obtain a smaller turning circle, to increase the agility in predetermined driving situations and/or to stabilize the motor vehicle in specific driving situations. Advantageously, the control unit is further configured to convert a detected steering specification using the rear axle steering system in the event of an identified failure of the front axle steering system, in particular as described above. Advantageously, the control unit is further configured to control actuators acting on the wheels of the motor vehicle in addition to adjusting a second wheel steering angle in order to convert a steering specification in the event of a failed front axle steering system, in particular brakes acting on the wheels and/or drive units acting on the wheels. The vehicle is thereby intended to follow a steering specification in a further improved manner as a result of braking and/or drifting movements.

The emergency steering system is preferably configured to carry out a method configured according to the invention, wherein the emergency steering system is advantageously configured to carry out the above-described method steps individually or in combination.

Other advantageous details, features and configuration details of the invention will be explained in greater detail in connection with the exemplary embodiments illustrated in the Figures (FIG.: Figure), in which:

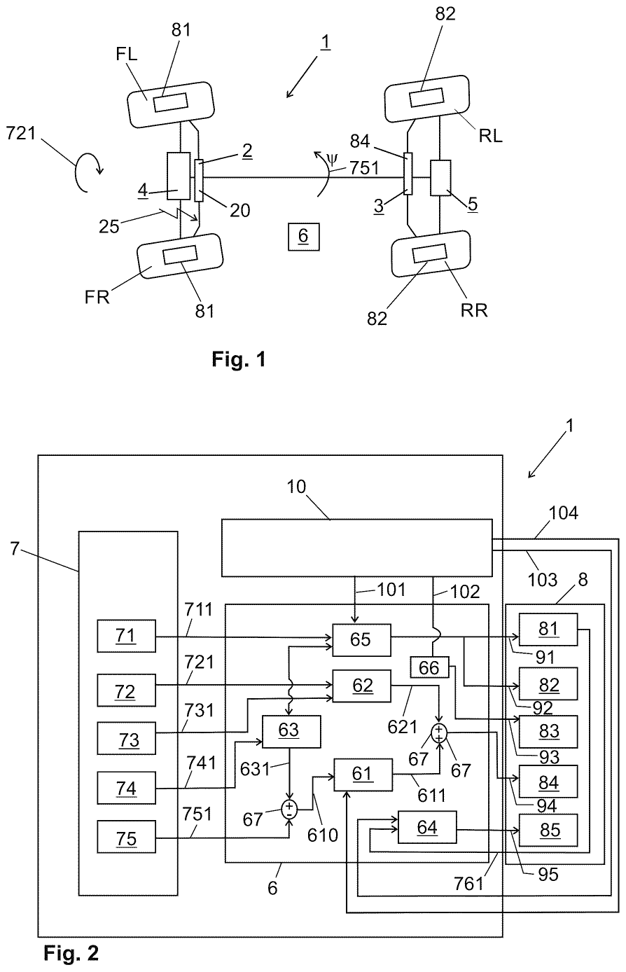

FIG. 1 shows a plan view of an exemplary embodiment which is illustrated in a highly simplified manner of an emergency steering system configured according to the invention;

FIG. 2 shows a block diagram of another exemplary embodiment of an emergency steering system which is configured according to the invention and which is configured to carry out a method configured according to the invention;

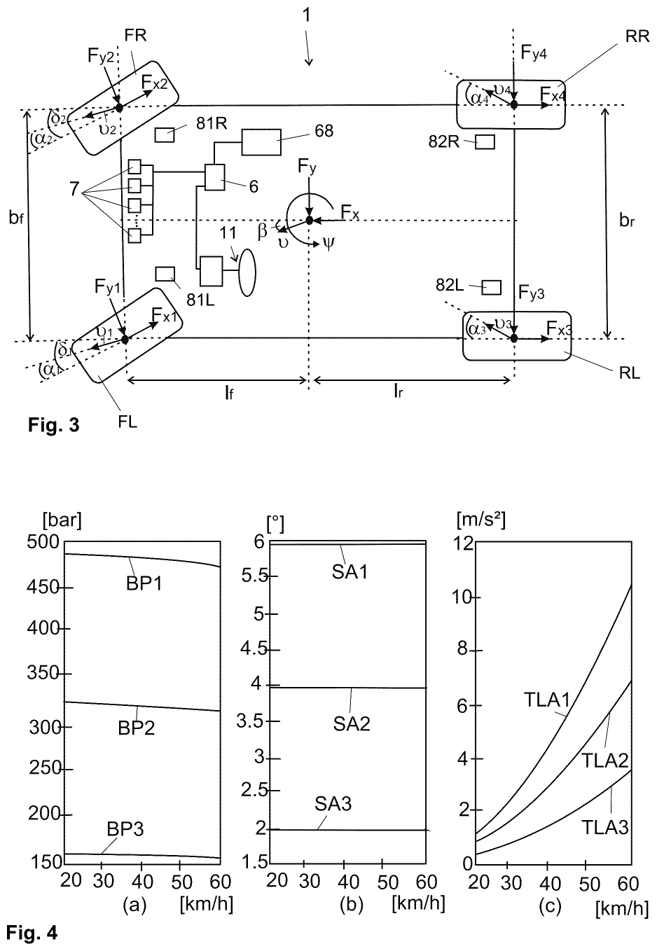

FIG. 3 shows a schematic illustration of an exemplary embodiment of a motor vehicle having an emergency steering system configured according to the invention;

FIG. 4 shows diagrammatic illustrations of a brake pressure, a steering angle and a target transverse acceleration in connection with an additional exemplary embodiment of a method configured according to the invention, wherein a brake pressure is determined on the basis of a stationary state of equilibrium;

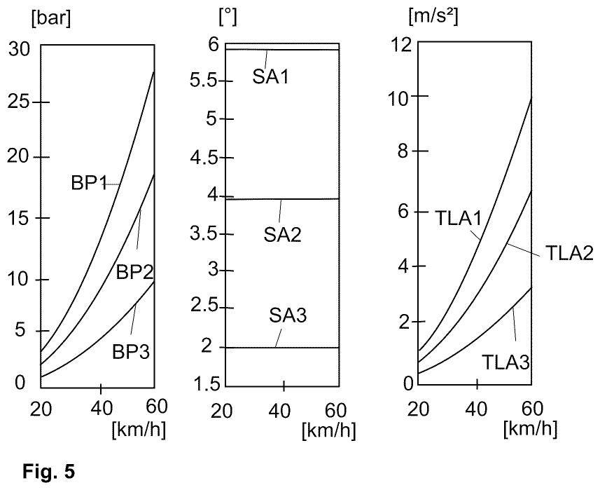

FIG. 5 shows diagrammatic illustrations of a brake pressure, a steering angle and a target transverse acceleration in connection with an additional exemplary embodiment of a method configured according to the invention, wherein a brake pressure is determined;

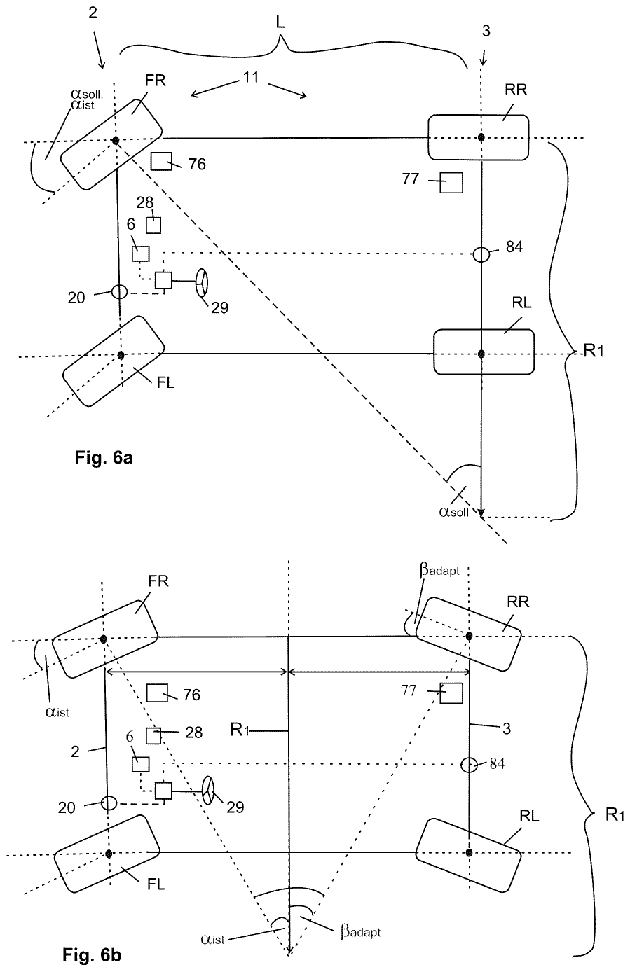

FIG. 6a shows a simplified, schematic illustration of an additional exemplary embodiment of an emergency steering system configured according to the invention in a motor vehicle in a normal operating mode with exclusively steered front wheels and non-steered rear wheels;

FIG. 6b shows a simplified, schematic illustration of the steering system according to FIG. 6a in a motor vehicle in the event of a failure of the front axle steering system;

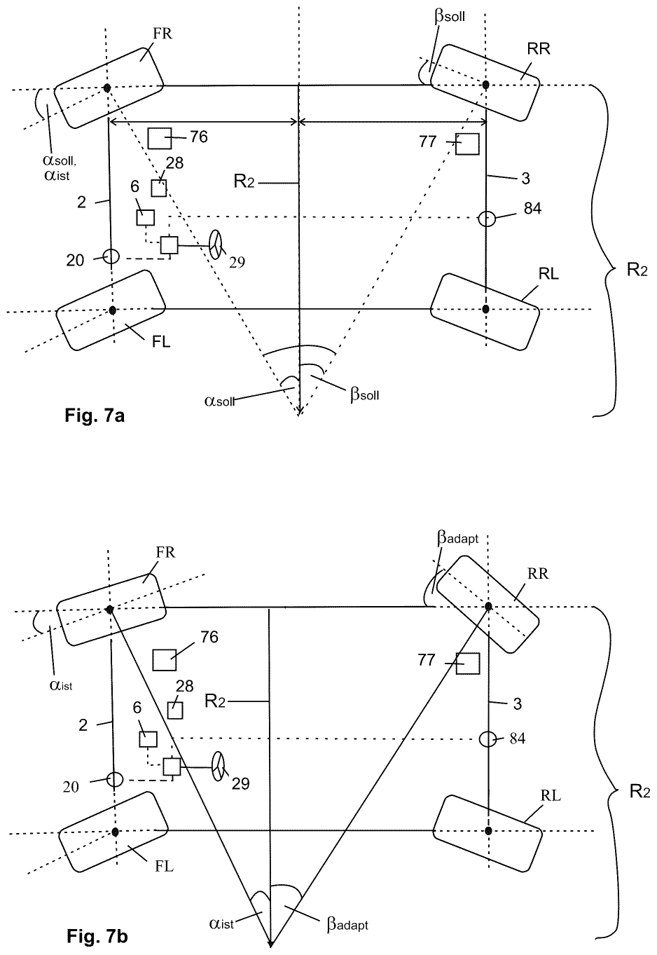

FIG. 7a shows a simplified, schematic illustration of an additional exemplary embodiment of an emergency steering system configured according to the invention in a motor vehicle in a normal operating mode with steered front wheels and steered rear wheels; and

FIG. 7b shows a simplified, schematic illustration of the steering system according to FIG. 7a in a motor vehicle in the event of a failure of the front axle steering system.

In the Figures, identical members are denoted with the same reference numerals and are therefore also sometimes explained only in connection with one of the Figures.

FIG. 1 illustrates a motor vehicle with a steer-by-wire steering system and a drive train which in particular comprises a front wheel drive 4 and a rear wheel drive 5. The steer-by-wire steering system has a front axle steering system 2 with a steering actuator 20 and a rear axle steering system 3 having an steering actuator 84. The left front wheel FL and the right front wheel FR can be steered with the front axle steering system 2 during normal operation. The left rear wheel RL and the right rear wheel RR can be steered with the rear axle steering system 3 during normal operation. The front wheels FL, FR each have in this case a front wheel brake as the front brake 81 and the rear wheels RL, RR each have a rear wheel brake as the rear brake 81. In the exemplary embodiment shown in FIG. 1, the occurrence of a fault 25 in relation to the front axle steering system 2 is now schematically depicted. This fault 25 may in particular be caused by an accident of the motor vehicle, wherein the fault 25 results in a failure of the front axle steering system 2. So that the motor vehicle can nevertheless be brought to a stop safely and with steering, the motor vehicle comprises an emergency steering system 1 which is configured to provide a capacity for steering in the event of failure of the front axle steering system 2.

The emergency steering system 1 comprises a control unit 6 which may in particular be identical to the control unit of the steer-by-wire steering system of the motor vehicle, wherein the steering actuator 84 of the rear axle steering system 3 and actuators 81, 82, 4, 5 of the motor vehicle are associated with the control unit 6 outside the original steer-by-wire steering system, and wherein a sensor unit for detecting a vehicle signal which relates to a steering specification 721 and additional sensor units for detecting additional vehicle signals are associated with the control unit 6. As a result of the association of the steering actuator 84 of the rear axle steering system and the additional actuators 81, 82, 4, 5 with the control unit 6, the control unit 6 can control these associated actuators 84, 81, 82, 4, 5 and use them to convert a steering specification 721. In this regard, the emergency steering system 1 is in particular an expansion of the functionally impaired steer-by-wire steering system and comprises in particular, in addition to the front axle steering system 2 affected by the fault 25, the rear axle steering system 3, the additional actuators 81, 82, 4, 5 which are associated with the control unit 6 of the emergency steering system 1, and the sensors which are associated with the control unit 6 of the emergency steering system 1.

In particular, the emergency steering system 1 according to the exemplary embodiment shown in FIG. 1 is configured to identify a fault 25 of the front axle steering system 2 and to detect, in the event of an identified fault 25 of the front axle steering system 2, vehicle signals, in particular vehicle signals relating to a steering specification 721, a position of a toothed rack of the front axle steering system 2 and a yaw rate 751 of the motor vehicle, with the associated sensor units which are not explicitly illustrated in FIG. 1, and to provide these detected vehicle signals for the control unit 6.

The control unit 6 of the emergency steering system 1 is configured to receive the vehicle signals 721, 751 and to generate, taking into consideration the received vehicle signals 721, 751, control signals for the steering actuator 84 of the rear axle steering system 3 and the additional actuators 81, 82, 4, 5, that is to say in particular the front brake 81, the rear brake 82, the front wheel drive 4 and the rear wheel drive 5, and to control these actuators 84, 81, 82, 4, 5 so that a received steering specification 721 is converted.

Another particularly advantageous exemplary embodiment of an emergency steering system 1 is shown as a block diagram in FIG. 2, wherein with reference to the block diagram the exemplary execution of a method configured according to the invention is also explained.

In this case, FIG. 2 illustrates an emergency steering system 1 which is configured to provide a steering capacity of a motor vehicle which has a steer-by-wire steering system having a front axle steering system and a rear axle steering system in the event of failure of the front axle steering system, with a control unit 6, wherein a large number of sensor units 7 and a large number of actuators 8 are associated with the control unit. In this exemplary embodiment, a sensor unit 71 for detecting an actuation of a brake pedal and for detecting an actuation of an accelerator pedal, a sensor unit 72 for detecting a steering specification, a sensor unit 73 for detecting the position of a toothed rack of the front axle steering system, a sensor unit 74 for detecting a vehicle speed and a sensor unit 75 for detecting a yaw rate of the motor vehicle are associated with the control unit 6 as sensor units 7. In this exemplary embodiment, a front brake 81, a rear brake 82, a damper unit 83 of the front wheel steering system, a steering actuator 84 of the rear axle steering system and a drive train 85 of the motor vehicle, in particular a front wheel drive and a rear wheel drive of the motor vehicle, are associated with the control unit 6 as actuators 8. In this case, in this exemplary embodiment, there is provision for an electric motor of a steering actuator of the front axle steering system to be able to be controlled via a short-circuiting circuit so that the phases of the electric motor are short-circuited and thus a movement of the toothed rack of the front wheel steering system is damped. Furthermore, a driving state determination device 10 which can advantageously access all the vehicle signals of the motor vehicle and which in particular are used to operate vehicle assistance systems of the motor vehicle, in particular an autonomous driving mode, so-called autopilot, is associated with the control unit 6. This driving state determination device 10 is configured to provide additional input variables for the control unit 6 of the emergency steering system 1, in particular input variables relating to the driving state of the motor vehicle.

The control unit 6 itself comprises diverse units for processing the signals which are received by the control unit 6. Thus, the control unit 6 comprises in this exemplary embodiment a yaw regulator 61, a unit 62 for establishing a steering actuator signal, a unit 63 for establishing a reference value for a yaw rate of the motor vehicle, a unit 64 for establishing a brake torque compensation, a unit 65 for calculating a respective brake pressure for the front brake 81 and the rear brake 82, a unit 66 for determining an activation or a deactivation of a damping of the movability of the toothed rack of the front axle steering system 2 and two units 67 for linking signals, in particular for adding or subtracting signals.

In the event of identification of a fault of the front axle steering system of the motor vehicle, in this case there is provision in this exemplary embodiment for a method for controlling the motor vehicle to be carried out by the emergency steering system 1 as described below. The sensor units 7 detect a vehicle signal 711 relating to an acceleration specification, a vehicle signal 721 relating to a steering specification, a vehicle signal 731 relating to a position of the toothed rack of the front axle steering system, a vehicle signal 741 relating to a vehicle speed and a vehicle signal 751 relating to a yaw rate of the motor vehicle, and provide these vehicle signals 711, 721, 731, 741, 751, 761 for the control unit 6. Furthermore, a vehicle signal 761 relating to the response of the front brake 81 of the motor vehicle is provided to the control unit 6. Furthermore, diverse vehicle signals 101, 102, 103, 104 which relate to the driving state of the motor vehicle are provided to the control unit 6 by the driving state determination device 10. The driving state determination device 10 establishes in particular whether brake torques have to be compensated for. Furthermore, it is determined in the driving state determination device 10 whether with respect to the drive train 85 a switch between a front wheel drive and a rear wheel drive has to be carried out. Furthermore, a carriageway situation determination is carried out by the driving state determination device 10 and it is established in particular whether the motor vehicle is moving on a motorway, across country or in urban traffic.

The vehicle signals 711, 721, 731, 741, 751, 761, 101, 102, 103, 104 detected by the control unit 6 are supplied here to different units 61, 62, 63, 64, 65, 66 of the control unit 6 which then generate the control signals 91, 92, 93, 94, 95 for the actuators 81, 82, 83, 84, 85 and control the actuators 81, 82, 83, 84, 85 accordingly. Thus, the vehicle signal 711 relating to an acceleration specification is transmitted to the unit 65 for calculating a respective brake pressure for the front brake 81 and the rear brake 82, which generates a control signal 91 for controlling the front brake 81 and a control signal 92 for controlling the rear brake 82 with additional consideration of vehicle signals 101 which relate to the driving state of the motor vehicle and with consideration of a reference value established by the unit 63 for establishing the reference value for the yaw rate. The front brake 81 and the rear brake 82 are then controlled in accordance with the respective control signal 91, 92. In this case, the front brake 81 and the rear brake 82 are used in a directionally dependent manner depending on the steering specification and acceleration specification which indicates whether the vehicle should be braked or not. If the brake input is used to produce a yaw moment on the vehicle, a compensation torque can be provided, to which end the unit 64 for establishing a brake torque compensation generates a corresponding control signal 95 for the drive train 85. The compensating torque which is generated by the control maintains the speed of the vehicle and comes from the drive train 85 of the vehicle, in particular from the front wheel drive or the rear wheel drive. The switch is determined here in the driving state determination device 10, for which reason the unit 64 for establishing a brake torque compensation receives from the driving state determination device 10 a corresponding vehicle signal 103 and receives from the front brake 81 a vehicle signal 761 relating to the response of the front brake, and generates the control signal 95 for the drive train 85 taking into consideration these vehicle signals 103, 761.

However, the main actuator for steering in the event of a defective front axle steering system is the rear axle steering system, wherein the steering angle of the steered wheels of the rear axle is adjusted via the steering actuator 84 of the rear axle steering system and the steering actuator 84 is controlled with a control signal 94 generated by the control unit 6. The steering actuator 84 is in principle in this exemplary embodiment controlled here with a forward steering component and a superimposed yaw regulator which damps disruptions, such as in particular the u-split braking. A unit 62 for establishing a steering actuator signal 621 establishes to this end a steering actuator signal 621 which is superimposed with a control signal 611 which is established by a yaw regulator 61 to form the control signal 94. The unit 62 for establishing the steering actuator signal 621 considers in this case in order to establish the steering actuator signal 621 the received vehicle signal 721 relating to a steering specification and the received vehicle signal 731 relating to a position of the toothed rack of the front axle steering system. The yaw regulator 61 takes into consideration for establishing the control signal 611 a superimposed signal comprising the reference value 631 for the yaw rate which is established by the unit 63 for establishing the reference value for the yaw rate and the yaw rate 751 detected by sensors. In this case, the yaw rate 751 detected by sensors is subtracted from the reference value 631 for the yaw rate and the result is provided to the yaw regulator 61 as an input variable 610. For establishing the reference value 631 for the yaw rate, the unit 63 takes into consideration for establishing the reference value for the yaw rate the vehicle signal 741 relating to a vehicle speed and signals which are provided by the unit 65 for calculating a respective brake pressure for the front brake 81 and the rear brake 82, in particular signals relating to the calculated brake pressure.

Furthermore, a control signal 92, with which a damper unit 83 of the front axle steering system is activated or deactivated, is generated by the unit 66 for determining an activation or a deactivation of a damping of the front axle steering system. For determining whether the damper unit 83 is activated and consequently a steering movement of the front axle should be damped or whether the damper unit 83 should not be activated or should be deactivated, the unit 66 for determining an activation or deactivation of a damping of the front axle steering system evaluates a vehicle signal 102 which is provided by the driving state determination device 10 and which relates to the driving state of the motor vehicle. The activation or deactivation of the damper unit 83 is dependent in this case in particular on the driving maneuver which is detected by the driving state determination device 10 as being “desired”.

In order to steer a vehicle in the event of a failure of the front axle steering system, the emergency steering system 1 consequently uses in this exemplary embodiment the rear axle steering system via the steering actuator 84 of the rear axle steering system, a yaw regulator, in particular for improved control of the steering actuator 84, selective brake applications on the front brake 81 and rear brake 82 by steer-by-brake, an adapted torque distribution by selectively applying drive torques via the drive train 85 and where necessary a brake pressure compensation.

With reference to FIG. 3, an additional exemplary embodiment of a two-track motor vehicle with a front left wheel FL, a front right wheel FR, a rear left wheel RL, a rear right wheel RR and an emergency steering system 1 is explained in greater detail. The emergency steering system 1 comprises a steer-by-wire steering system 11, wherein the steer-by-wire steering system 11 comprises a control unit 6 which may in particular be in the form of a driver assistance system which is configured to carry out a method for steering the motor vehicle in a supporting manner, particularly in the event that the steer-by-wire steering system 11 is affected by faults, and a steering specification cannot be converted or at least cannot be converted alone by control of a steering actuator, which acts on the steerable wheels of the motor vehicle via a connecting rod, of the steer-by-wire steering system 11, particularly as a result of a functional impairment of the front axle steering system.

For steering in a supporting manner, the control unit 6 comprises a unit 68 for determining a brake specification which is configured to control a brake 81L, 81R, 82L, 82R which is associated with a respective wheel FL, FR, RL, RR of the motor vehicle in order to thereby bring about a desired yaw action of the motor vehicle in accordance with a steering specification. To this end, in this exemplary embodiment, by means of the steer-by-wire steering system 11 a steering specification which is introduced via a steering handle by a driver is detected and a desired yaw rate is provided by the control unit 6 taking into consideration the detected steering specification.

Using sensors 7 which are connected to the control unit 6 and which are configured to detect different driving state information items, a current actual yaw rate of the motor vehicle is determined and taking into consideration the determined actual yaw rate a brake specification for the brakes 81L, 81R, 82L, 82R is determined in such a manner that, as a result of a brake application, that is to say a selective actuation in particular of the brakes 81L, 81R associated with the front wheels FL, FR or the brakes 82L, 82R associated with the rear wheels RL, RR, the actual yaw rate is approximated to the desired yaw rate in accordance with the determined brake specification. The control unit 6, in particular the unit 68 associated with the control unit 6, for determining a brake specification determines in this case in this exemplary embodiment as the brake specification a brake pressure for the brakes 81L, 81R, 82L, 82R associated with the wheels FL, FR, RL, RR. In this case, in this exemplary embodiment there is provision, depending on the situation, for either the left brakes 81L, 82L to be actuated with the determined brake pressure and the right brakes 81R, 82R to be actuated with a brake pressure of zero or for the right brakes 81R, 82R to be actuated with the determined brake pressure and the left brakes 81L, 82L to be actuated with a brake pressure of zero. This is based on the notion that a force difference with respect to a longitudinal force Fₓ should be generated in order to be able to achieve the desired intended yaw rate.

According to a first variant of the exemplary embodiment according to FIG. 3, there is provision in this instance for the determination of the brake specification, that is to say in this exemplary embodiment of the brake pressure of the brakes 81L, 81R, 82L, 82R of the motor vehicle, to be determined on the basis of a two-track model. FIG. 4 sets out to this end by way of example for three different steering angles SA1, SA2, SA3 which are illustrated in the graph of FIG. 4(b) as angles in degrees against the vehicle speed in km/h (km: kilometer, h: hour) corresponding desired yaw rates TLA1, TLA2, TLA3 which are illustrated in FIG. 4(c) as acceleration in m/s² (m: meter, s: second) against the vehicle speed in km/h and determined brake pressures BP1, BP2, BP3 which are illustrated in the graph of FIG. 4(a) as pressure in bar against the vehicle speed in km/h. Therefore, there results from a steering specification in accordance with the steering angle SA1 a desired yaw rate TLA1 and a brake pressure BP1. In this variant, therefore, for a smaller steering angle a smaller brake pressure is also produced. It can further be seen that in this variant the brake pressure decreases at a higher driving speed.

The brake pressures result in this case from the force difference ΔFₓ of the longitudinal forces Fₓ based on the two-track model, wherein the force difference is determined with

$$Δ {F}_{x} = \ddot{ψ} * \frac{2 {c}_{α} {l}_{f}^{2} + 4 {c}_{α} {l}_{f} {l}_{r} - m {l}_{f} {v}^{2} + 2 {c}_{α} {l}_{r}^{2} + m {l}_{r} {v}^{2}}{2 v} ,$$

taking into consideration that

$${δ}_{f} \approx 0 ,$$

$${δ}_{r} \approx 0 ,$$

$${α}_{f} = {δ}_{f} - β - \frac{\dot{ψ} {l}_{f}}{v} = {α}_{1 , 2} ,$$

$${α}_{r} = {δ}_{r} - β + \frac{\dot{ψ} {l}_{r}}{v} = {α}_{3 , 4} ,$$

$${F}_{y} = {c}_{α} * α ,$$

$$( \dot{ψ} + \dot{β} ) m v = ( {F}_{y 1} + {F}_{y 2} ) + ( {F}_{y 3} + {F}_{y 4} ) ,$$

$$\ddot{ψ} = Δ {F}_{x} + ( {F}_{y 1} + {F}_{y 2} ) * {l}_{f} - ( {F}_{y 3} + {F}_{y 4} ) * {l}_{r} ,$$

with the lateral load displacement being disregarded F_{y1}=F_{y2} and F_{y3}=F_{y4},

$$Δ {F}_{x} = {F}_{x 1} * \frac{{b}_{f}}{2} - {F}_{x 2} * \frac{{b}_{f}}{2} ( with {F}_{x 1} or {F}_{x 2} equal to 0 ) ,$$

and solved for the stationary states \ddot{ψ}=0, \dot{β}=0 when the equations are linked,

$${F}_{x} * r = p * {c}_{P}$$

Fₓ=ΔFₓ, because the brakes are actuated only at one wheel and Fₓ=0 at the other wheel, depending on whether ΔFₓ>0 or ΔFₓ<0,
N_{b}=Fₓ*r (as a requirement placed on the brake torque N_{b}), and

$$p = \frac{{F}_{x} * r}{{c}_{P}}$$

(in order to determine the brake pressure).

In this case, there applies to the equations:
F_{y}: transverse force,
Fₓ: longitudinal force,
CoG: center of mass,
α: lateral displacement angle of tire,
δ: steering angle of wheel,
v: local speed,
β: king pin inclination angle of chassis,
\dot{ψ}: yaw speed,
\ddot{ψ}: yaw acceleration,
m: vehicle mass,
c_{α}: lateral tire rigidity,
b: track width,
l: spacing from center of gravity,
N_{b}: brake torque,
r: wheel radius,
p: brake pressure,
cₚ: brake pressure-to-brake torque coefficient (to be established by experiment),
Index “f”: front,
Index “r”: rear,
Index “1”: front left,
Index “2”: front right,
Index “3”: rear left,
Index “4”: rear right.

The force difference established according to the above formula is recalculated to form the brake pressure by the control unit 6 or the determination unit 68, which is associated with the control unit 6, taking into consideration the wheel diameter of the wheels FL, FR, RL, RR and the so-called c_p value (brake pressure to torque). This brake pressure is scaled with a scaling factor less than 1, wherein a scaling factor with a value between 0.05 and 0.1 has been found to be particularly advantageous. In this case, the control unit 6 is further configured in this variant to evaluate a current driving maneuver from vehicle information items which can be established in particular by means of the sensors 7, wherein the scaling factor is fixed depending on the evaluation of the driving maneuver.

In a second variant of the exemplary embodiment shown in FIG. 3, unlike the first variant the brake specification is calculated, wherein a desired yaw moment to be achieved which is proportional to the desired yaw rate is determined from the desired yaw rate and the desired yaw moment is multiplied by a value for a current driving speed of the motor vehicle. The control unit 6 is configured in this second variant to determine the force difference ΔFₓ of the longitudinal forces Fₓ according to the following relationship:

ΔFₓ=\ddot{ψ}*v*C, with C being a constant which is used as an adjustment factor. The brake pressure is then determined again for

$$p = \frac{{F}_{x} * r}{{c}_{P}} .$$

According to this second variant, FIG. 5 sets out by way of example for three different steering angles SA1, SA2, SA3 which are illustrated in the graph of FIG. 5(b) as angles in degrees against the vehicle speed in km/h (km: kilometer, h: hour) corresponding desired yaw rates TLA1, TLA2, TLA3 which are illustrated in FIG. 5(c) as acceleration in m/s² (m: meter, s: second) against the vehicle speed in km/h and determined brake pressures BP1, BP2, BP3 which are illustrated in the graph of FIG. 5(a) as pressure in bar against the vehicle speed in km/h. In this case, the constant C was fixed with the value 95. The required brake pressure increases here with the speed so that the driver has the feeling that the vehicle is under-steering more powerfully. This is advantageous if the main steering system is based on the rear wheels and not on the front wheels, particularly if there is no more capacity for steering the front wheels in an all-wheel steering system as a result of a fault, for example, as a result of an accident.

FIG. 6a to FIG. 6b illustrate an exemplary embodiment of a steering system in a motor vehicle having a front axle steering system 2 as the first steering system and a rear axle steering system 3 as the second steering system. Here, the steering system is a steer-by-wire steering system 11 which can be included in particular by an emergency steering system, as already described. The front axle steering system 3 of the steer-by-wire steering system 11 comprises a first steering actuator 20 for steering the front wheels FL, FR of the motor vehicle. The rear axle steering system 3 of the steer-by-wire steering system 11 comprises a second steering actuator 84 for steering the rear wheels RL, RR of the motor vehicle. Furthermore, the steer-by-wire steering system 11 comprises a steering wheel as a steering handle 29. The desired steering angles are, particularly during normal operation of the steer-by-wire steering system 11, preferably calculated from the speed of the motor vehicle and the position of the steering handle 29. In particular in the case of an at least partial failure of the front axle steering system 2, a kinematic curve radius R1, R2 which in particular is taken as a basis for determining the necessary steering angle correction on the fault-free rear axle steering system 3, is associated with a steering specification.

Via the steering handle 29, a driver of the motor vehicle can predetermine a steering specification for steering the motor vehicle, wherein a kinematic radius R1, R2 which the motor vehicle follows as a result of the steering specification is advantageously associated with the steering specification. Alternatively, a steering specification can also be predetermined by a driver assistance system 28 of the motor vehicle.

The steer-by-wire steering system 11 of the motor vehicle further comprises a first sensor unit 76 for detecting a current first wheel steering angle α_Ist of the front wheels FL, FR, that is to say of a wheel steering angle which the front wheels FL, FR actually take up, and a second sensor unit 77 for detecting a current second wheel steering angle of the rear wheels RL, RR, that is to say of a wheel steering angle which the rear wheels RL, RR actually take up. The sensor units 76, 77 are connected in this case to a control unit 6 of the steer-by-wire steering system 11. This control unit 6 is configured to determine from the detected steering specification a first desired steering angle α_Soll for the front wheels FL, FR and a second desired steering angle β_Soll for the rear wheels RL, RR of the motor vehicle. Furthermore, the control unit 6 is configured to control the steering actuator 84 of the rear axle steering system 3 of the steer-by-wire steering system 11, in the event of a functional impairment of the front axle steering system 2 taking into consideration the first desired steering angle α_Soll for the front wheels FL, FR, taking into consideration the second desired steering angle β_Soll for the rear wheels RL, RR and taking into consideration the first wheel steering angle α_Ist detected by the first sensor unit 76, in such a manner that it adjusts a second wheel steering angle β_adapt for the rear wheels RL, RR in order to convert the steering specification. The steer-by-wire steering system 11 is illustrated in different driving situations in FIG. 6a to FIG. 7b.

In this case, FIG. 6a shows the steer-by-wire steering system 11 in a fault-free normal operating mode, wherein a detected steering specification with an associated kinematic radius R1 is converted alone by the front axle steering system 2. The rear axle steering system 3 does not change the wheel steering angle of the rear wheels RL, RR in order to convert the steering specification. In FIG. 6a, therefore, the second desired steering angle β_Soll for the rear wheels RL, RR is determined at 0°. A desired steering angle α_Soll which is determined for converting the steering specification for the front wheels FL, FR corresponds in this case to the first wheel steering angle α_Ist detected by sensors.

For example, as a result of a collision in which a steering gear mechanism of the steer-by-wire steering system 11 has been damaged, the situation may now occur that the front axle steering system 2 is no longer completely functional and the front wheels FL, FR cannot be adjusted any longer via the steering actuator 20 so that they can take up the first desired steering angle α_Soll for converting the detected steering specification. Such a situation is illustrated in FIG. 6b. Here, in order to carry out the steering specification the same kinematic radius R1 as in FIG. 6a is intended to be converted. As a result of the damage to the front axle steering system 2, however, the front wheels FL, FR do not take up the desired steering angle «_Soll determined by the control unit 6, but instead only the wheel steering angle «_Ist which is detected by the sensor unit 76. The control unit 6 identifies here the impairment of the front axle steering system 2 and subsequently determines taking into consideration the previously determined first desired steering angle α_Soll which corresponds to the angle α_Soll illustrated in FIG. 6a for the front wheels FL, FR, and determines taking into consideration the actual first wheel steering angle α_Ist detected by means of the sensor unit 76 a wheel steering angle β_adapt for the rear wheels RL, RR and adjusts this angle β_adapt by means of the steering actuator 84 of the rear axle steering system 3. The determination of the wheel steering angle is carried out in this case according to

$${β}_{a d a p t} = a tan ( tan ( {α}_{S o l l} ) - tan ( {α}_{Ist} ) ) .$$

If this angle can be adjusted precisely, the motor vehicle can be steered in accordance with the steering specification with the same kinematic radius R1 as shown in FIG. 6a. Otherwise, at least the steering behavior of the motor vehicle in the case according to FIG. 6b can be approximated to the steering behavior of the motor vehicle in the case according to FIG. 6a in an improved manner, in particular in a case not shown here if the determined steering angle β_adapt is greater than an adjustable steering angle. In this case, the steering movement of the motor vehicle is advantageously further approximated by a selective braking and a deliberately introduced yaw rate, in particular as described in the already-explained exemplary embodiments, to the originally desired steering movement of the motor vehicle and consequently to the original steering specification.

FIG. 7a shows the steer-by-wire steering system 11 in another normal operating situation, in which, in order to convert a steering specification with an associated kinematic radius R2, both for the front wheels FL, FR a first desired steering angle α_Soll different from 0° and for the rear wheels RL, RR a second desired steering angle β_Soll different from 0° are determined. The determined desired steering angle α_Soll, β_Soll are then accordingly adjusted by means of the steering actuators 20, 84 during fault-free operation.

If a functional impairment of the front axle steering system 2 now occurs here so that a detected first wheel steering angle α_Ist is smaller than a first desired steering angle α_Soll determined for the front wheels FL, FR, the control unit 6 of the steer-by-wire steering system 11 determines, taking into consideration the first desired steering angle α_Soll determined in order to convert the steering specification for the fault-free case, taking into consideration the second desired steering angle β_Soll determined in order to convert the steering specification for the fault-free case, and the first wheel steering angle α_Ist detected by means of the sensor unit 76, an adapted second wheel steering angle β_adapt which is intended to be adjusted by means of the steering actuator 84 of the rear axle steering system 3 and which replaces the desired specification for the originally established desired steering angle β_Soll. This second wheel steering angle β_adapt is determined for

$${β}_{a d a p t} = a tan ( tan ( {α}_{S o l l} ) + tan ( {β}_{S o l l} ) - tan ( {α}_{Ist} ) ) .$$

In this case, as already set out with respect to FIG. 6a, it also applies that at least when this second wheel steering angle β_adapt can be adjusted, the kinematic radius R2 which is associated with the steering specification can be precisely converted. Otherwise, the steering specification is at least approximated in an improved manner, in particular in a corresponding manner as already set out with respect to the failure situation described with reference to FIG. 6b.

The exemplary embodiments which are illustrated in the Figures and explained in connection therewith serve to explain the invention do not limit it.

### LIST OF REFERENCE NUMERALS

1 Emergency steering system
11 Steer-by-wire steering system
2 Front axle steering system
20 Steering actuator of the front axle steering system
25 Fault of the front axle steering system
28 Driver assistance system
29 Steering handle
3 Rear axle steering system
4 Front wheel drive
5 Rear wheel drive
6 Control unit
61 Yaw regulator
610 Input variable of the yaw regulator (61)
611 Control signal of the yaw regulator (61)
62 Unit for establishing the steering actuator signal
621 Steering actuator signal
63 Unit for establishing the reference value for the yaw rate
631 Established reference value for the yaw rate
64 Unit for establishing a brake torque compensation
65 Unit for calculating a respective brake pressure for the front brake (81) and the rear brake (82)
66 Unit for determining an activation/deactivation of a damping of the front axle steering system (2)
67 Unit for linking signals
68 Unit for determining a brake specification
7 Sensor units
71 Sensor unit for detecting the actuation of a brake pedal/accelerator pedal
72 Sensor unit for detecting a steering specification
73 Sensor unit for detecting the position of a toothed rack of the front axle steering system (2)
74 Sensor unit for detecting the vehicle speed
75 Sensor unit for detecting the yaw rate of the motor vehicle
76 Sensor unit for detecting a current first actual wheel steering angle of the front wheels
77 Sensor unit for detecting a current second actual wheel steering angle of the rear wheels
711 Vehicle signal relating to an acceleration specification
721 Vehicle signal relating to a steering specification
731 Vehicle signal relating to a position of the toothed rack of the front wheel steering system
741 Vehicle signal relating to a vehicle speed
751 Vehicle signal relating to a yaw rate of the motor vehicle
761 Vehicle signal relating to the response of a front brake (81)
8 Actuators of the motor vehicle
81 Front brake
81L Left front brake
81R Right front brake
82 Rear brake
82L Left rear brake
82R Right rear brake
83 Damper unit of the front axle steering system (2)
84 Steering actuator of the rear axle steering system (3)
85 Drive train
91 Control signal for the front brake (81)
92 Control signal for the rear brake (82)
93 Control signal for a damper unit (83) of a toothed rack of the front axle steering system
94 Control signal for the steering actuator (84) of the rear axle steering system (3)
95 Control signal for the drive train (85)
Driving state determination device
101 Vehicle signal relating to the driving state of the motor vehicle
102 Vehicle signal relating to the driving state of the motor vehicle
103 Vehicle signal relating to the driving state of the motor vehicle
104 Vehicle signal relating to the driving state of the motor vehicle
FL Left front wheel
FR Right front wheel
RL Left rear wheel
RR Right rear wheel
L Axle spacing between first axle (5) and second axle (8)
R1, R2 Kinematic curve radius associated with a steering specification
α_Soll First desired steering angle for the first wheels
α_Ist First (measured) wheel steering angle of the first wheels
β_Soll Second desired steering angle for the second wheels
β_adapt Second wheel steering angle of the second wheels

1-22. (canceled)

23. A method for controlling a motor vehicle which has a steer-by-wire steering system having a front axle steering system and a rear axle steering system in the event of an identified fault of the front axle steering system, the method comprising:
detecting vehicle signals relating to a steering specification, a position of a toothed rack of the front axle steering system and a yaw rate of the motor vehicle;
providing the detected vehicle signals to a control unit;
in order to convert the steering specification, generating, by the control unit, a first control signal for controlling a steering actuator of the rear axle steering system, wherein the first control signal is generated taking into consideration the steering specification, the position of the toothed rack of the front axle steering system and the yaw rate; and
controlling the steering actuator of the rear axle steering system with the generated first control signal.

24. The method as claimed in claim 23, wherein the control unit generates, for converting the steering specification, a second control signal for controlling a front brake of the motor vehicle and/or a rear brake of the motor vehicle, wherein the front brake and/or the rear brake are controlled with the generated second control signal.

25. The method as claimed in claim 24, wherein a vehicle signal relating to an acceleration specification is additionally detected, wherein taking into consideration the acceleration specification a brake pressure for the front brake and/or the rear brake is calculated as the second control signal.

26. The method as claimed in claim 25, wherein a vehicle signal relating to a vehicle speed is additionally detected, wherein a reference value for a yaw rate of the motor vehicle is established taking into consideration the vehicle speed and the calculated brake pressure.

27. The method as claimed in claim 26, wherein, taking into consideration the steering specification and the position of the toothed rack of the front axle steering system, a steering actuator signal for the steering actuator of the rear axle steering system is generated, a yaw regulator generates a control signal for determining a torque distribution at wheels of the motor vehicle taking into consideration the yaw rate of the motor vehicle and the first control signal is generated from a superimposition of the steering actuator signal and the control signal.

28. The method as claimed in claim 27, wherein a difference between the detected vehicle signal relating to the yaw rate of the motor vehicle and the established reference value for the yaw rate is provided to the yaw regulator as an input variable.

29. The method as claimed in claim 23, wherein a specification with respect to a desired yaw rate to be achieved of the motor vehicle is provided, taking into consideration a current actual yaw rate of the motor vehicle, a brake specification for at least one of the wheels of the motor vehicle is determined in order to bring the actual yaw rate closer to the desired yaw rate, and a brake application is carried out in accordance with the determined brake specification.

30. The method as claimed in claim 29, wherein the brake specification is determined based on a two-track model, wherein the specification with respect to the desired yaw rate is supplied as the input variable to the two-track model and using the two-track model for a presumed stationary state of the motor vehicle as the output variable a brake torque difference resulting therefrom is established between the wheels, wherein the brake specification is determined from the brake torque difference.

31. The method as claimed in claim 29, wherein a scaling factor is applied to the determined brake torque difference, wherein the scaling factor is less than 1, and in particular is fixed with a value in a range from 0.05 to 0.2, wherein the scaling factor is preferably set to a higher value the lower the steering action which can still be provided by the steering system.

32. The method as claimed in claim 23, wherein additionally a vehicle signal relating to the response of a front brake of the motor vehicle is detected and provided to the control unit, wherein the control unit generates a brake torque compensation as the third control signal taking into consideration the response of the front brake of the motor vehicle and a drive train of the motor vehicle is controlled with the third control signal.

33. The method as claimed in claim 23, wherein a movement of the toothed rack of the front axle steering system is damped.

34. The method as claimed in claim 23, wherein a driving state determination device determines, taking into consideration available vehicle signals, a driving state of the motor vehicle, wherein the determined driving state is provided to the control unit.

35. The method as claimed in claim 34, wherein the control unit takes into consideration the driving state for generating at least one of the control signals.

36. The method as claimed in claim 23, wherein a first wheel steering angle of the front wheels is additionally detected and using the rear axle steering system in order to convert the steering specification a second wheel steering angle of the rear wheels is adjusted, a first desired steering angle for the front wheels is determined and a second desired steering angle for the rear wheels is determined from the detected steering specification, and the second wheel steering angle is determined taking into consideration the determined first desired steering angle, the determined second desired steering angle and the detected first wheel steering angle.

37. The method as claimed in claim 36, wherein the second wheel steering angle is determined with
$${β}_{adapt} = a tan ( tan ( {α}_{Soll} ) + tan ( {β}_{Soll} ) - tan ( {α}_{Ist} ) ) , where$$
$${β}_{adapt} = second wheel steering angle ,$$
$${α}_{Soll} = first desired steering angle for the front wheels ;$$
$${β}_{Soll} = second desired steering angle for the rear wheels ; and$$
$${α}_{Ist} = detected first wheel steering angle .$$

38. An emergency steering system for providing a capacity for steering a motor vehicle having a steer-by-wire steering system having a front axle steering system and a rear axle steering system, in the event of failure of the front axle steering system, comprising:
a control unit, wherein a steering actuator of the rear axle steering system and actuators of the motor vehicle outside the steer-by-wire steering system are associated with the control unit; and
a sensor unit for detecting a vehicle signal which relates to a steering specification and additional sensor units for detecting additional vehicle signals;
wherein the control unit is configured to receive vehicle signals from the sensor units and to generate, from the received vehicle signals for converting the received steering specification, control signals for the steering actuator, which is associated with the control unit, of the rear axle steering system and the actuators of the motor vehicle outside the steer-by-wire steering system.

39. The emergency steering system as claimed in claim 38, wherein the additional sensor units comprise at least one of the following sensor units: sensor unit for detecting the actuation of a brake operating element; sensor unit for detecting the actuation of an acceleration operating element; sensor unit for detecting the position of a toothed rack of the front axle steering system; sensor unit for detecting the vehicle speed; sensor unit for detecting the yaw rate of the motor vehicle.

40. The emergency steering system as claimed in claim 38, wherein the actuators of the motor vehicle outside the steer-by-wire steering system comprise at least one of the following actuators: front brake of the motor vehicle; rear brake of the motor vehicle; drive train of the motor vehicle.

41. The emergency steering system as claimed in claim 38, wherein a short-circuiting circuit of an electric motor of a steering actuator of the front axle steering system is further associated with the control unit, wherein the short-circuiting circuit is configured in the event of actuation to short-circuit phases of the electric motor and consequently to damp a movement of the toothed rack of the front axle steering system.

42. The emergency steering system as claimed in claim 38, wherein:
a driving state determination device is further associated with the control unit, wherein the driving state determination device is configured to determine a driving state of the motor vehicle taking into consideration detected vehicle signals and to provide it as an additional input signal for the control unit, wherein the control unit is further configured to consider the provided driving state for generating at least one of the control signals; and
the emergency steering system further comprises a sensor unit for detecting a current first wheel steering angle of the front wheels, wherein the control unit is further configured to determine from the steering specification a first desired steering angle for the front wheels and/or a second desired steering angle for the rear wheels of the motor vehicle, and is further configured to control the steering actuator of the rear axle steering system, in the event of an at least partial failure of the front axle steering system taking into consideration the first desired steering angle for the front wheels and/or taking into consideration the second desired steering angle for the rear wheels and the detected first wheel steering angle, in such a manner that the steering actuator adjusts a second wheel steering angle for the rear wheels in order to convert the steering specification.
